(19) United States
(12) Patent Application Publication
(10) Pub. No.: US 2003/0037110 A1
(43) Pub. Date: Feb. 20, 2003

(54) Method for providing area chat rooms, method for processing area chats on terminal side, computer-readable medium for recording processing program to provide area chat rooms, apparatus for providing area chat rooms, and terminal-side apparatus for use in a system to provide area chat rooms

(75) Inventor: Yuki Yamamoto, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/082,204

(22) Filed: Feb. 26, 2002

(30) Foreign Application Priority Data
Aug. 14, 2001 (JP) 2001-245846

(51) Int. Cl. G06F 15/16; H04M 3/42

(52) U.S. Cl. 709/204; 455/416

(57) ABSTRACT

The present invention provides a method or an apparatus to provide area chat rooms where unspecified users each carrying a portable terminal can exchange message or the like in real time as well as for creating or searching for chat rooms based on location information and displaying locations of participants during a chat. The apparatus includes chat rooms each associated with a specific location, accepts an entrance request with a current location and a remark attached from a portable terminal, and distributes a user of the portable terminal to a chat room whose area contains a current location. Then, each of the terminals displays the location and remark of participants on its screen.

### CROSS-REFERENCE TO RELATED APPLICATIONS

This application claims priority from Japanese patent application Serial no. 2001-245846 filed Aug. 14, 2001, the contents of which are incorporated by reference herein.

### BACKGROUND OF THE INVENTION

1. Field of the Invention

The present invention relates to a system for providing on-line chat service using mobile communications terminals such as PDA (personal digital assistance) equipped with capabilities to communicate via cell phones and computer networks. In particular, it relates to a method for providing area chat rooms, a method for processing area chats on the terminal side, recording medium for a processing program for providing area chat rooms, and apparatus for providing area chat rooms; which make it possible to create or search for chat rooms based on location information and provide location information of chat room participants.

2. Description of the Related Art

Chat room service is a service which allows computer or cell phone users to have text-based conversations with each other via a cell phone network or computer network in real time. A chat can be conducted on a one-to-one basis or with the participation of more than two people simultaneously.

With conventional chat services, unspecified people, regardless of their whereabouts, participate in a chat room set up in virtual worlds according to their tastes and interests, exchange messages or information in real time via the Internet or the like. Various types of chat room are provided. Participant scans elect and enter a chat room freely according to their purpose and exchange messages with other participants in the same chat room (prior art 1).

Technology disclosed by Japanese Patent Laid-Open No. 2000-167233 “MEETING/COMMUNICATION SUPPORTING SYSTEM” (inventor: Masanobu Kujirada) involves making users set key data via a mobile communications terminal, identifying the locations of the users in a peer-to-peer or through key data matching at a center, notifying them if they are located close to each other, and allowing them to communicate with each other (by enabling real-time conversations such as phone conversations or chats or enabling e-mail exchanges) (prior art 2).

Since chat rooms are essentially installed in virtual worlds, it is possible to create a chat room using specific place names conceptually. But, it is not possible to communicate with a person in a specific location in the real world by specifying him/her as shown in prior art 1. The actual whereabouts of speakers are also unknown, thus the participants present little sense of reality. Moreover, it is not possible to estimate the credibility of the information provided by speakers. Consequently, the participant cannot communicate with them unreservedly.

On the other hand, with the technology of prior art 2, it is possible to match neighboring people by specifying conditions and allow them to communicate with each other, but people cannot communicate with each other if they are not located close to each other. Besides, even if it is learned that a person is located nearby, it is not possible to identify his/her whereabouts because his/her location cannot be displayed visually.

Furthermore, matched partners located close to each other at a certain time point may move away from each other during the communications, which will make it difficult to keep track of each other's locations throughout the communications.

### SUMMARY OF THE INVENTION

An object of the present invention is to provide a novel area chat room in order for users to chat in an on-line chat room associated with a specific place in the real world.

Another object of the present invention is to implement processes for allowing participants who are chatting in the above described area chat room to keep track of their partners' locations.

The method according to the present invention provides chat rooms where unspecified users each carrying a portable terminal can exchange character information or the like in real time. The method comprises the steps of managing access to area chat rooms each associated with a specific location, accepting an entrance request with the current location of the terminal or a user-specified location attached, from the above described terminal for permission to enter one of the above described area chat rooms, allowing entrance into any appropriate area chat room which covers the above described current location or specified location, accepting a remark request with the current location of the terminal attached, from the above described terminal for permission to make a remark and delivering the remark to the terminals of the other participants of the above described area chat room by attaching the location of the above described terminal, and accepting location update information from the above described terminal and delivering the above described location update information to the terminals of the other participants of the above described area chat room.

Also, the terminal-side area chat processing method for use in a system which provides chat rooms where unspecified users each carrying a portable terminal can exchange character information or the like in real time. The method comprising the steps of sending a server of said system an entrance request with the current location of the terminal or a user-specified location attached, requesting for permission to enter an area chat room provided by said system and associated with a specific location, sending the server of said system a remark request with the current location of said terminal attached when the user is in said area chat room, receiving the current locations and remarks of all the participants as well as map data corresponding to the range of said area chat room from said system and displaying said map data, charted locations of the participants, and remarks of the participants on a display screen of said terminal when the user is in said area chat room, and informing the server of said system about the current location of said terminal at designated intervals or on designated occasions.

Also the computer-readable medium for recording a processing program to provide area chat rooms where unspecified users each carrying a portable terminal can exchange character information or the like in real time. The program causes the computer managing access to area chat rooms each associated with a specific location, accepting an entrance request with the current location of the terminal or a user-specified location attached, from said terminal for permission to enter one of said area chat rooms, and allowing entrance into any appropriate area chat room whose area includes said current location or specified location, accepting a remark request, with the current location of the terminal attached, from said terminal for permission to make a remark, and delivering the remark to the terminals of the other participants of said area chat room by attaching the location of said terminal, and accepting location update information from said terminal and delivering said location update information to the terminals of the other participants of said area chat room.

Also, the apparatus for providing area chat rooms where unspecified users each carrying a portable terminal can exchange character information or the like in real time. The apparatus comprises the room log-in management means for managing access to area chat rooms each associated with a specific location, the entrance processing means for accepting an entrance request with the current location of the terminal or a user-specified location attached, from said terminal for permission to enter one of said area chat rooms, and allowing entrance into any appropriate area chat room whose area includes said current location or specified location, the remark accepting means for accepting a remark request, with the current location of the terminal attached, from said terminal for permission to make a remark, and delivering the remark to the terminals of the other participants of said area chat room by attaching the location of said terminal, and the location-update information delivery means for accepting location update information from said terminal and delivering said location update information to the terminals of the other participants of said area chat room.

Also, the terminal-side apparatus for use in a system which provides chat rooms where unspecified users each carrying a portable terminal can exchange character information or the like in real time. The apparatus comprises the entrance processing means for sending a server of said system an entrance request with the current location of the terminal or a user-specified location attached, requesting for permission to enter an area chat room provided by said system and associated with a specific location, the remark processing means for sending the server of said system a remark request, with the current location of said terminal attached, when the user is in said area chat room, the display processing means for receiving the current locations and remarks of all the participants as well as map data corresponding to the range of said area chat room from said system and displaying said map data, charted locations of the participants, and remarks of the participants on a display screen of said terminal when the user is in said area chat room, and the location information update processing means for informing the server of said system about the current location of said terminal at designated intervals or on designated occasions.

### BRIEF DESCRIPTION OF THE DRAWINGS

FIG. 1 is a diagram showing a configuration example of a system according to the present invention.

FIG. 2 is a diagram showing a display example on a terminal.

FIG. 3 is a diagram showing a configuration example of an area chat management apparatus according to an embodiment of the present invention.

FIG. 4 is a diagram showing a data configuration example and display example of a room data.

FIG. 5A is a diagram showing a data configuration example of a room list.

FIG. 5B is a diagram showing a display example of a room list.

FIG. 6 is a diagram showing a data configuration example of a room property.

FIG. 7 is a diagram showing a data configuration example of novel entrance information.

FIG. 8 is a diagram showing a data configuration example of remark information.

FIG. 9 is a diagram showing a data configuration example of exit information.

FIG. 10 is a diagram showing a configuration example of a terminal according to an embodiment of the present invention.

FIG. 11 is a diagram showing a data configuration example of location update information.

FIG. 12 is a diagram showing a data configuration example of a chat log record.

FIG. 13 is a diagram showing a display example of remark location search results.

FIG. 14 is a processing flowchart of room entrance processes.

FIG. 15 is a processing flowchart of room creation processes.

FIG. 16 is a processing flowchart of push notification setting processes.

FIG. 17 is a processing flowchart of information or notification receiving processes.

FIG. 18 is a processing flowchart of display processes for the latest speaker.

FIG. 19 is a processing flowchart of participant location search processes.

### DETAILED DESCRIPTION OF THE PREFERRED EMBODIMENTS

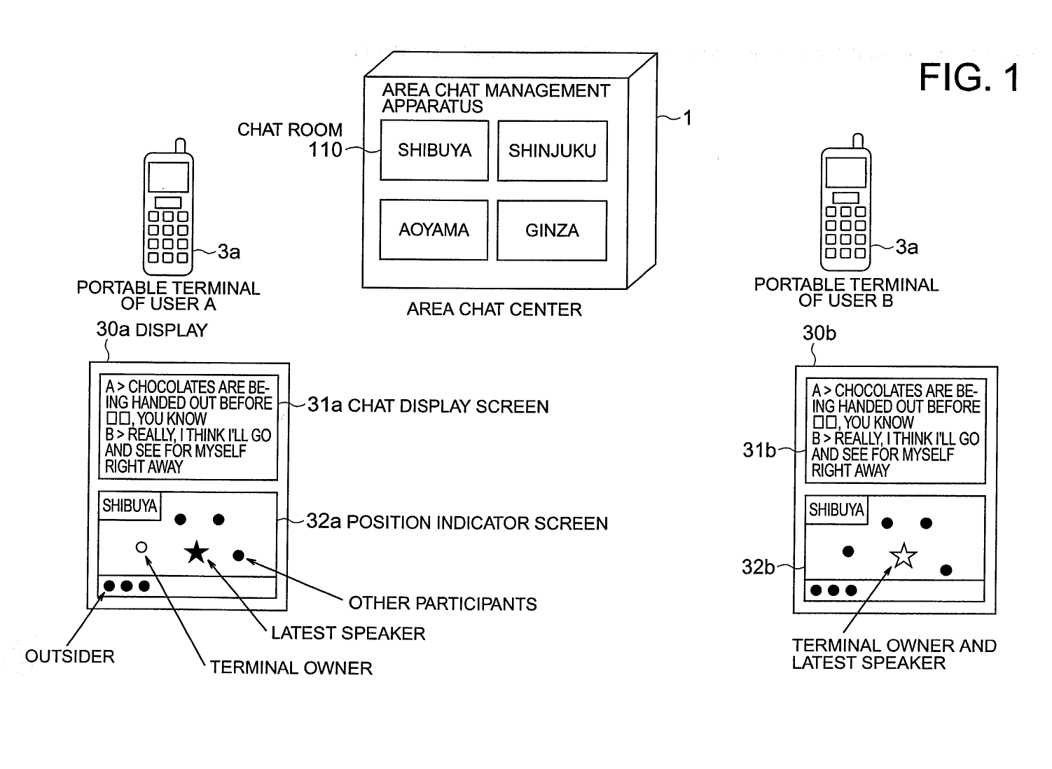

FIG. 1 shows a configuration example of a system which implements the present invention. An area chat management apparatus 1 installed at an area chat center manages one or more chat rooms 110 set up being associated with specific places (location information) such as Shibuya or Shinjuku. A terminal 3 is a portable terminal which can communicate with the area chat management apparatus 1 via a communications network such as a portable telephone network or an Internet. According to this embodiment, the terminal 3 is a portable phone capable of communicating with the area chat management apparatus 1 via the communications network such as the Internet or the portable phone network.

A chat room 110 provided by the area chat management apparatus 1 is set up by a service provider in advance or based on a message from a user requesting to create a room. The chat room 110 is set up, being associated with a specific area, which is set at a certain point. The specific area, which can be defined arbitrarily by the service provider, is generally considered to be one area such as a 3-km-diagonal square around the position (latitude, longitude, and altitude) of Shibuya Station with the sides facing north, south, east and west or one area within a 3-km radius around the position (latitude, longitude, and altitude) of Shinjuku Station

The chat room 110 comes in two types: one type anyone can enter (general type) and one type which only members are allowed to enter (members-only type). In the case of members-only chat rooms 110, authorized participants (members) are registered and managed for each chat room 110. A display 30 on the terminal 3 comprises a chat display screen 31 and a position indicator screen 32. The chat display screen 31 is a display area which displays remarks exchanged among the participants of the chat room 110. The position indicator screen 32 is a display area which displays map data of the area covered by the chat room, location information of chat room participants, etc.

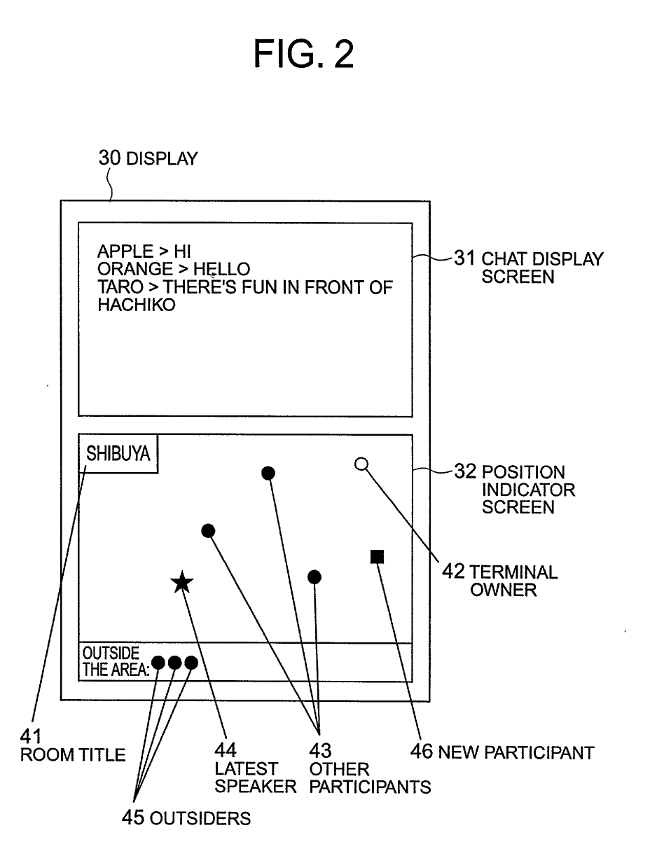

FIG. 2 shows a display example on a terminal. The chat display screen 31 on the terminal 3 displays remark messages, each paired with the nickname of the appropriate participant, in the order of their arrival in the chat room 110.

The position indicator screen 32 displays a room title 41, which is the name of the chat room 110, and indicates the locations of all the participants by designated marks on the map data. The locations of the participants are indicated by differently shaped, differently colored, or blinking marks so that the owner 42 of the terminal 3, other participants 43, the latest speaker 44, outsiders 45 who are participants from outside the area covered by the chat room 110, new participants 46, etc. can be distinguished at a glance. For example, a terminal owner 42 is indicated by a white circle and other participants 43 are indicated by black circles. Besides, the latest speaker 44 is indicated by a star-shape and new participants 46, if appropriate, are indicated by squares. The terminal owner 42 is indicated by a white circle if he/she is the latest speaker, and is indicated by a white square if he/she is a new participant 46. Of the other participants 43, those who are outside the area of the chat room 110 are indicated by black circles as outsiders 45 in an outsider pane. If the latest speaker 44 is an outsider, the appropriate black circle in the outsider pane changes to a black star. In this way, the users can identify the location of each other while exchanging remarks in real time. In particular, since the latest speaker is displayed in distinction from the other participants, the locations of speakers can be identified easily.

In FIG. 1, user A who is located in Shibuya wishes to enter a chat room 110. When user A enters a nickname for use during chats and a remark “Chocolates are being handed out before [ ] [ ], you know” in a terminal 3a, the terminal 3a sends an entrance request message to the area chat management apparatus 1 by attaching identification information of the terminal 3a and the current location (latitude, longitude, and altitude) obtained via GPS (global positioning system) to the remark.

The area chat management apparatus 1 selects “Shibuya” as the appropriate chat room 110, based on the current location attached to the entrance request message, and sends map data for the area of the Shibuya room as well as the participant identification numbers, location information, remarks in the chat, etc. of the users (for example, user B) who are already in the chat room 110 to the terminal 3a. At the same time, the area chat management apparatus 1 prepares novel entrance information consisting of the identification number, location information, and remark of the new participant (user A) and sends it to the terminals 3 of all the participants, including the terminal 3b of user B. Consequently, the remark of user A is displayed in the chat display screen 31a on the terminal 3a of user A as follows:

User A>“Chocolates are being handed out before [ ][ ], you know.”

Besides, the position indicator screen 32a displays the map data corresponding to the area of the Shibuya room as background. The location of user A (the terminal owner) and the locations of the other participants are charted on the map, being marked in such a way that they can be distinguished from each other.

Similarly, the chat display screen 31b on the terminal 3b of user B displays the remark of user A additionally. The position indicator screen 32b displays the location of user A as a square mark, which indicates a new participant, in the displayed area of the chat room 110.

If user B, who has read the remark of user A, enters a remark “Really, I think I'll go and see for myself right away” and sends it to the area chat management apparatus 1 together with current location information of user B, the area chat management apparatus 1 sends remark information, which consists of the remark and location information received from user B, to the terminals 3 of all the participants, including the terminal 3a of user A.

Upon receiving the remark information, the terminal 3a of user A displays the remark and location information received from the area chat management apparatus 1 on the chat display screen 31a as shown in FIG. 1:

User A>“Chocolates are being handed out before [ ][ ], you know.”

User B>“Really, I think I'll go and see for myself right away.”

Besides, the position indicator screen 32a displays the newly received current location of user B on the map as a mark which indicates the latest speaker.

In the example of FIG. 1, the position indicator screen 32a displays the location of user A as a white circle (meaning the terminal owner), and the location of user B as a black star (meaning the latest speaker). At the same time, the position indicator screen 32b on the terminal 3b displays the location of user A as a black circle and indicates the location of user B himself/herself by a while star-shape as the terminal owner and the latest speaker.

Subsequently, each time user A makes a remark, the terminal 3a obtains its current location via the GPS and sends a message and a location information to the area chat management apparatus 1. The area chat management apparatus 1 sends the remark of user A and location information to all the participants, including user B. The terminal 3b of user B receives remark information of user A (remark and location information), displays the new remark on the chat display screen 31b, updates the location of user A based on the location information contained in the remark information, and changes the mark of user A on the position indicator screen 32b to the mark of the latest speaker.

While the user is logged in to the chat room 110, the terminal 3 obtains the current location of the user and sends it to the area chat management apparatus 1 at regular intervals or upon reception of a message. The area chat management apparatus 1 sends the received location information of the terminal 3 to other users as location change information. The terminals 3 of the other users display the updated location of the given participant.

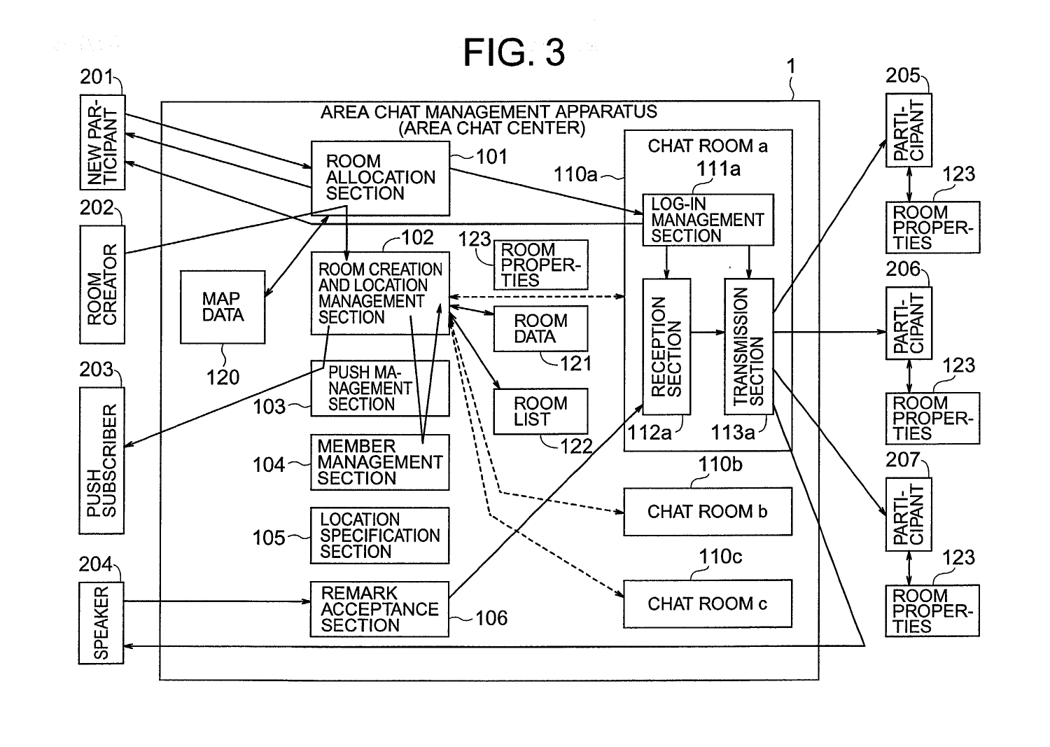

Various means implementing the present invention and processes of the present invention will be described in more detail below. FIG. 3 shows a configuration example of the area chat management apparatus 1.

The area chat management apparatus 1 comprises a room allocation section 101, a room creation and location management section 102, a push management section 103, a member management section 104, a location specification section 105, a remark acceptance section 106, chat rooms 110a, 110b, 110c, . . . , map data 120, room data 121, a room list 122, and room properties 123.

The room allocation section 101 provides means for forwarding an entrance request message from the terminal 3 of a new participant 201 who wishes to enter a chat room 110 to an appropriate chat room 110 (the chat room 110a, in this case) or forwarding a room creation message from a room creator 202 who wishes to create a chat room 110 to the room creation and location management section 102.

The room allocation section 101 either distributes messages to chat rooms 110 right away based on the location information contained in the messages from terminals 3 or searches the room data 121 of the chat rooms 110, returns a room list 122 of appropriate chat rooms 110 to the terminals 3, and make the users to select chat rooms 110.

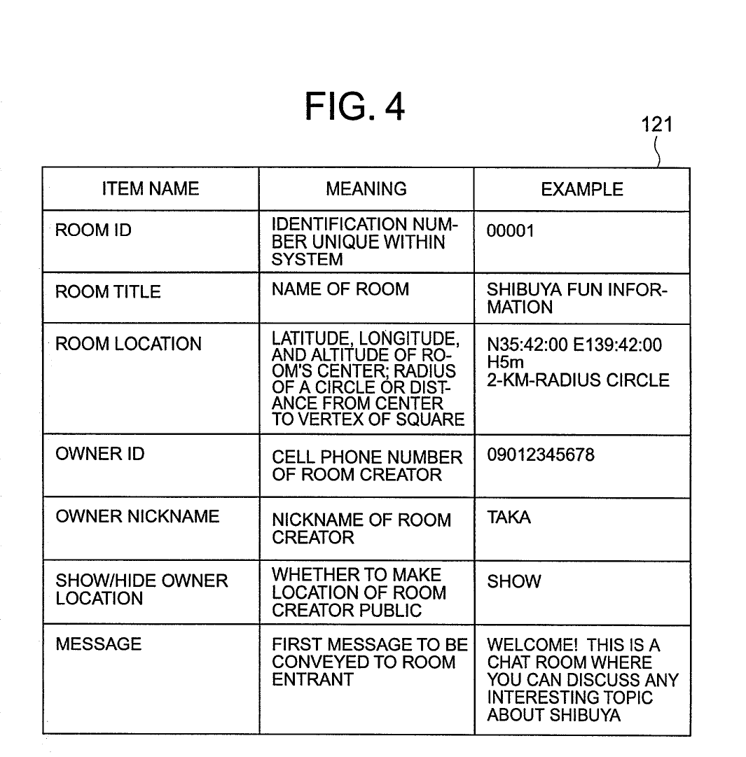

FIG. 4 shows a configuration example of room data. The room data 121 consists of a room ID which is a unique identification number within the system; a room title which is the name of the chat room 110; room location which is the latitude, longitude, and altitude and area setting information (the radius of a circle or the distance from the center to a vertex of a square) of the center of the chat room 10; an owner ID (the cell phone number of the room creator) which is the identification number of the room creator; an owner nickname which is the handle name of the room creator during chats; a Show/Hide Owner Location setting which indicates whether to make the location of the room creator public; and the first message to be delivered to room entrants.

For example, the room data in FIG. 4 indicates that a chat room 110 named “Shibuya Fun Information” is set up in an area (circular) within a 2-km radius around a point at Lat. 35 deg. 42′00″N, Long. 139 deg. 42′00″E, Alt. 5 m. The room ID (00001) is issued when the room data 121 is prepared by the room creation and location management section 102.

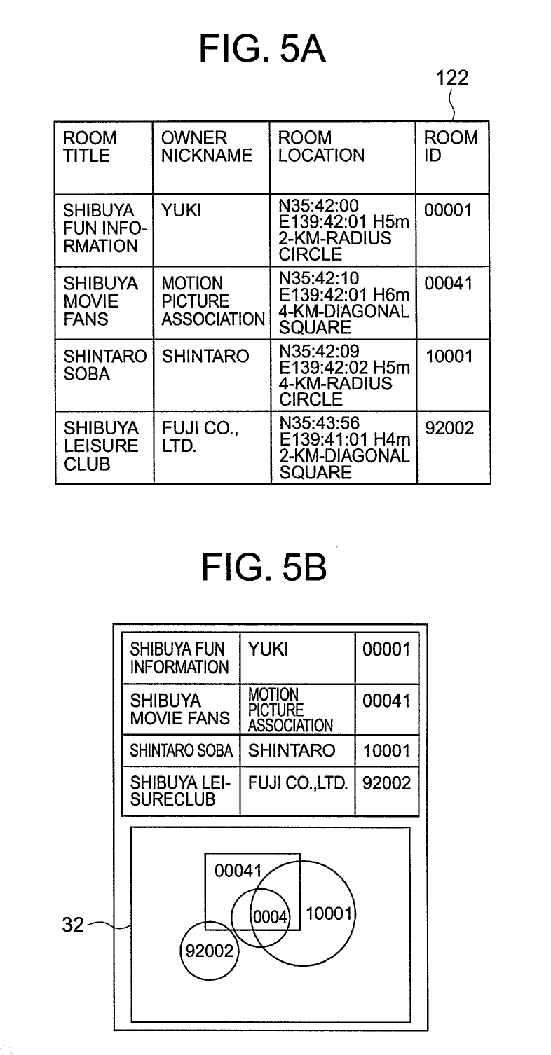

FIG. 5A shows a configuration example of the room list 122. The room list 122 contains the room title, owner nickname, room location, and room ID.

The room list 122 in FIG. 5A shows that there are four chat rooms whose areas contain the current location (35 deg. 42′00″N, Long. 139 deg. 42′00″E) of the user.

The terminal 3 displays the room list 122 returned from the area chat management apparatus 1 on the display 30. Chat rooms may be charted on a map in the position indicator screen 32 as shown in FIG. 5B instead of listing them only in text form.

The room creation and location management section 102 provides means for creating a chat room 110 based on the settings information contained in the room creation message received from the room allocation section 101 and managing the location, etc. of the chat room 110 by using the room data 121.

The push management section 103 provides means for managing the registration of the users (push subscribers 203) who wishes to receive push information about chat rooms 110 which satisfy particular conditions and giving push notification to appropriate push subscribers 203 when a chat room 110 is created. Push notifications include, real area push, specified-area push, and specified-creator push. The real area push is information delivered to registered push subscribers 203 to notify them that a chat room whose area includes their current locations has been created. The specified-area push is information delivered to registered push subscribers 203 to notify them that a chat room whose area includes the places specified by them has been created. The specified-creator push is information delivered to registered push subscribers 203 to notify them that a user specified by them has created a chat room 110.

The member management section 104 provides means for registering and managing the participants (members) of any members-only chat room 110 with limited participants when it is created as well as for informing the members about the opening of any chat room 110 created by any of the registered members (specified-creator push).

The location specification section 105 provides means for acquiring the latitude, longitude, and altitude of a place specified in a message received from a terminal 3.

The remark acceptance section 106 provides means for accepting remark messages from speakers 204 and distributing them to appropriate chat rooms 110.

The chat room 110 is a unit of chat groups associated with locations set by the administrator of the area chat center or users. FIG. 3 shows three chat rooms 110a, 110b, and 110c, but the number of chat rooms is not restricted. Each chat room 110 comprises a log-in management section 111, reception section 112, and transmission section 113.

Each log-in management section 111 provides means for managing the entrance, exit, location information updates of participants with respect to its own chat room, based on the room properties 123.

The room properties 123 are data concerning the locations of chat room 110 participants and state of a chat.

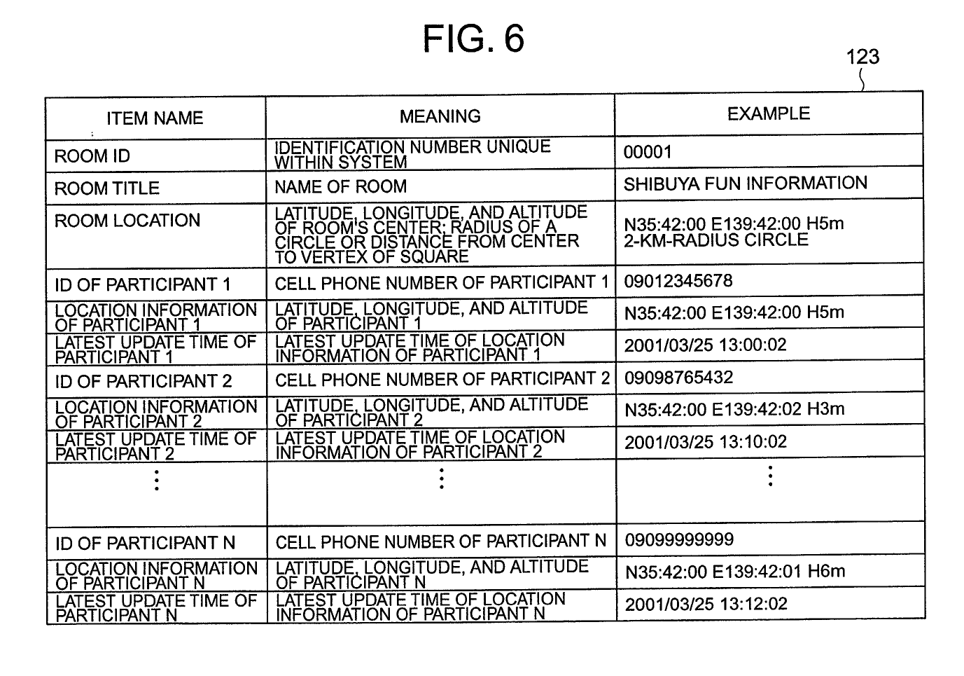

FIG. 6 shows a data configuration example of room properties 123. The room properties 123 consist of room ID, room title, room location, and information about individual participants. The participant information includes the ID (cell phone number), location information (latitude, longitude, and altitude), and latest update time of the participant. The location information and latest up date time are changed each time location update information is received from the given participant.

Each log-in management section 111 sends the room properties 123, the information needed to display remarks or locations on the terminal 3, and other information to the participants of its own chat room 110. Also, if an entrance request message is received, the log-in management section 111 prepares novel entrance information 130 and sends it to the terminals 3 of the other participants who are already in the room.

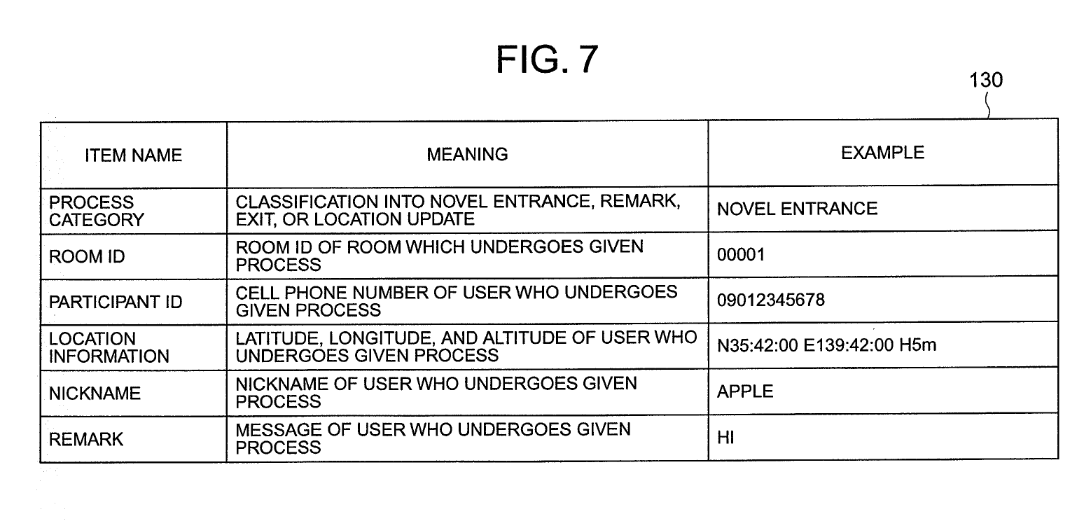

FIG. 7 shows a data configuration example of novel entrance information. The novel entrance information 130 consists of process category (“Novel entrance”), room ID, participant ID, location information, nickname, and remark. The participant ID is the identification number (cell phone number) of the terminal 3 of a new entrant 201. The location information is the latitude, longitude, and altitude of the new entrant 201. it is made public only if the new entrant 201 sets his/her location information to Show. The participant ID, location information, nickname, and remark are taken from the data contained in the entrance request message of the new entrant 201.

When a remark message is received, the log-in management section 111 prepares remark information 131 and sends it to the terminals 3 of the participants.

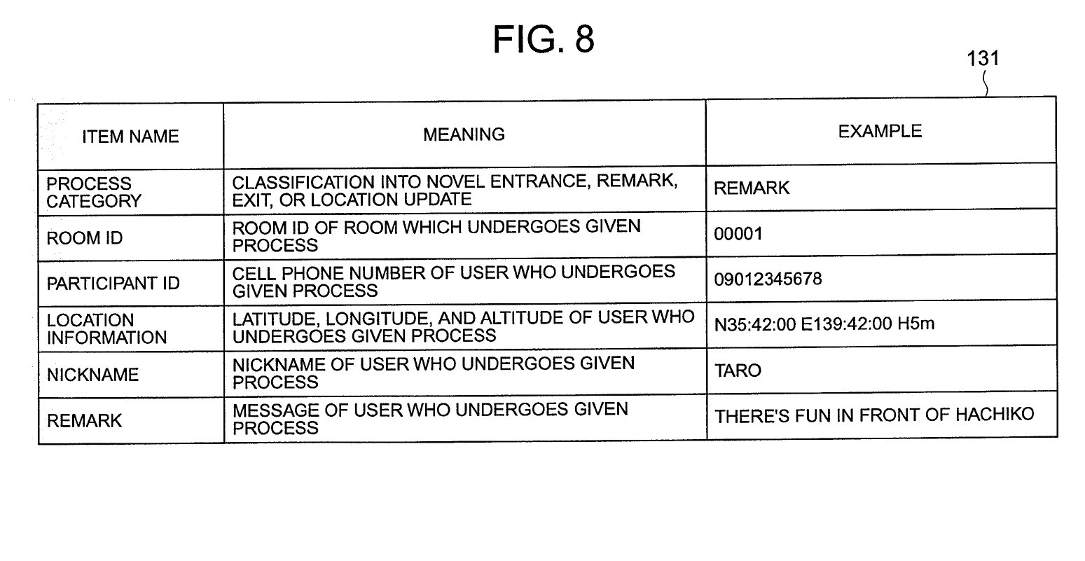

FIG. 8 shows a data configuration example of remark information 131. The remark information 131 consists of process category (“Remark”), room ID, participant ID, location information, nickname, and remark.

The log-in management section 111 sends a connection check signal periodically to the terminals 3 of the participants of its own chat room 110 to check whether connection is maintained. If connection is broken, the log-in management section 111 prepares exit information 132.

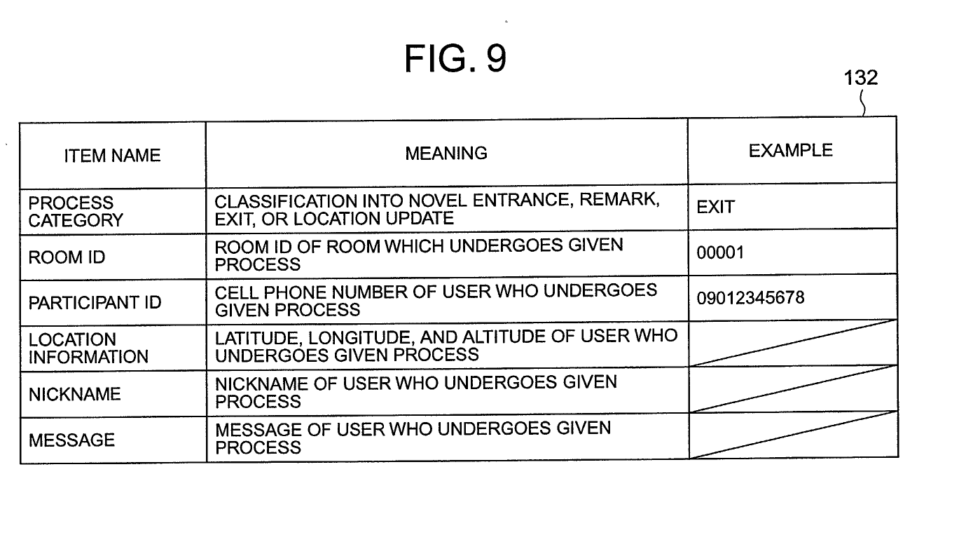

FIG. 9 shows a data configuration example of exit information 132. The exit information 132 consists of process category (“Exit”), room ID, and participant ID.

The reception section 112 provides means for accepting remark messages of speakers 204 in its own chat room from the remark acceptance section 106.

The transmission section 113 provides means for sending the messages and information received by the log-in management section 111 or reception section 112 to the terminals 3 of the participants.

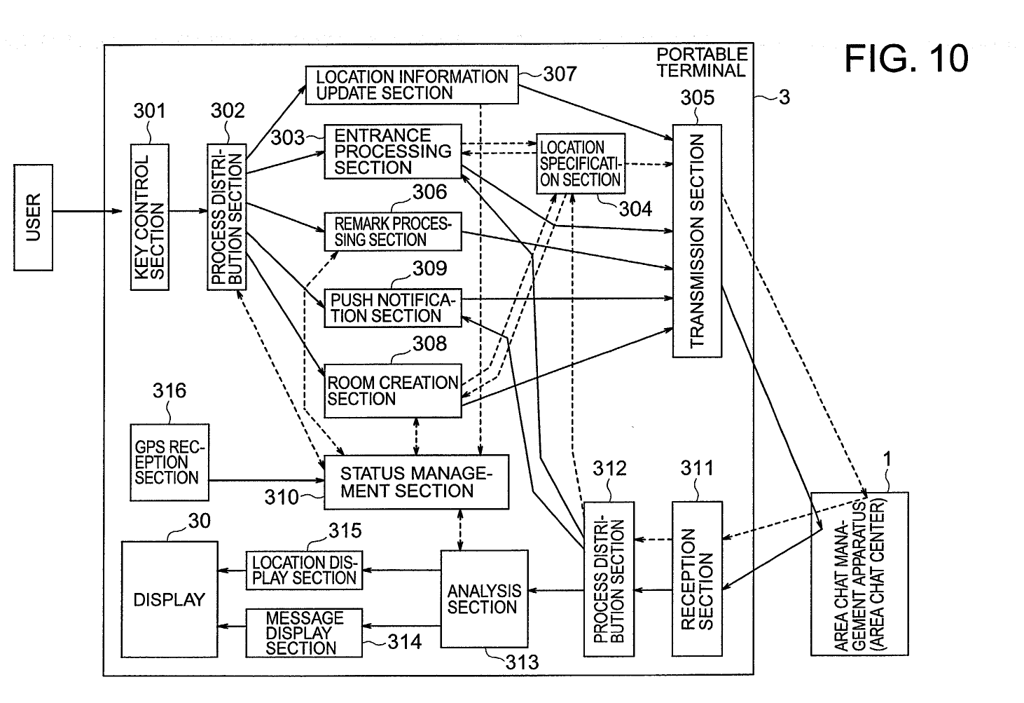

FIG. 10 shows a configuration example of the terminal 3. The terminal 13 comprises a key control section 301, process distribution section 302, entrance processing section 303, location specification section 304, transmission section 305, remark processing section 306, location information update section 307, room creation section 308, push notification section 309, status management section 310, reception section 311, process distribution section 312, analysis section 313, message display section 314, location display section 315, and GPS reception section 316.

The key control section 301 provides means for controlling input means such as keys (not shown) mounted on the terminal 3.

The process distribution section 302 provides means for displaying a menu on the display 30 and distributing processes to processing sections based on entered requests.

The entrance processing section 303 provides means for handling entrance into a chat room 110 whose area includes the user's current location or a specified location.

The location specification section 304 provides means for displaying a location specification menu in response to an input with a location specified, allowing a location specification method to be selected and a search key to be entered, sending them to the area chat management apparatus 1, and acquiring the latitude, longitude, and altitude of the specified place.

The transmission section 305 provides means for sending the messages and information received from processing sections to the area chat management apparatus 1.

The remark processing section 306 provides means for creating remark messages.

The location information update section 307 provides means for preparing location update information 320 on occasions or at intervals, specified by the user, based on the latitude, longitude, and altitude acquired from the GPS reception section 316 via the status management section 310.

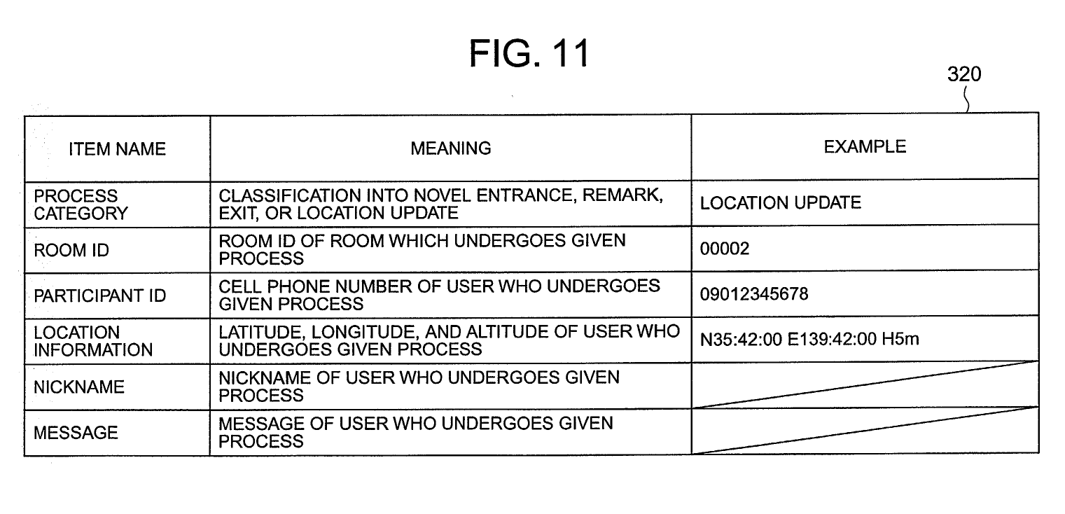

FIG. 11 shows a data configuration example of location update information 320. The location update information 320 consists of process category (“Location update”), room ID, participant ID, and location information.

The room creation section 308 provides means for creating a room creation message based on a user input or setting.

The status management section 310 provides means for storing and managing the user information entered or selected by the user, the terminal identification number allocated uniquely to the terminal 3 by the common carrier, the current location acquired by the GPS reception section 316, the room properties 123 received from the area chat management apparatus 1, etc.

The reception section 311 provides means for receiving information sent by the area chat management apparatus 1. The information received include novel entrance information 130 concerning new entrants, remark information 131 concerning remarks by participants, location update information 320 which is notification about the current locations of participants, exit information 132 which is notification about the exit of participants, etc.

The process distribution section 312 provides means for distributing information received by the reception section 311 to appropriate processing sections based on the process categories of the received information.

The analysis section 313 provides means for analyzing the information received by the reception section 311 and passing derived data to appropriate processing sections.

The message display section 314 provides means for displaying remarks contained in the novel entrance information 130 or remark information 131, together with the nicknames, on the chat display screen 31 of the display 30.

The location display section 315 provides means for analyzing the location information derived by the analysis section 313 and charting the locations of appropriate participants on the map 32 in the position indicator screen 32 of the display 30.

The GPS reception section 316 provides means for receiving the latitude, longitude, and altitude of the user's current location from GPS.

Processes run by apparatus according to the present invention will be described in detail below.

(1) Entrance Into Chat Rooms

Participation in or entrance into a chat room 110 can be entrance into a chat room whose area includes the current location of the user or entrance into a chat room whose area includes a location specified by the user.

(a) Entrance Into a Chat Room Set up at the Current Location of the User

1. The process distribution section 302 displays a menu prompting the user to select processes of an area chat service provided by the area chat management apparatus 1. Menu items include, for example, “enter a room at current location,” “specify a place for a room to enter,” “create a room,” “subscribe to push notification by specifying an area,” “subscribe to push notification by specifying a creator,” “make settings for delivery of location information,” etc. The process distribution section 302 accepts key entry (“enter a room at current location” is selected) from a user (new participant 201) who wants to participate in a chat room created at his/her current location, via the key control section 301 on the terminal 3, and passes processing to the entrance processing section 303.

2. The entrance processing section 303 allows the user to enter a nickname, select a Show/Hide Location setting, and enter the first remark to be displayed. When the user has completed all the entries and a selection of log-in is accepted, it passes the nickname and Show/Hide Location setting to the status management section 310. While retaining the nickname and Show/Hide Location setting, the status management section 310 acquires the location information (latitude, longitude, and altitude) of the current location via the GPS reception section 316. The entrance processing section 303 prepares an entrance request message by attaching a terminal identification number (cell phone number of the terminal 3 of the new participant 201)—which is allocated uniquely to the terminal 3 by the common carrier—to the current location information acquired from the status management section 310, the nickname entered, the Show/Hide Location setting selected, and the remark. Then, the entrance request message is sent to the area chat management apparatus 1 by the transmission section 305.

3. Upon receiving the entrance request message, the area chat management apparatus 1 accesses the room creation and location management section 102 which manages room data 121, via the room allocation section 101, searches for chat rooms 110 which contain the location information of the received entrance request message, creates a room list 122 such as the one shown in FIG. 5A, and sends it to the terminal 3 of the new entrant 201.

4. The entrance processing section 303 receives the room list 122 from the area chat management apparatus 1 via the reception section 311 and process distribution section 312. The entrance processing section 303 displays the room list 122 in list form or map form, as shown in FIG. 5B. When the user selects a room, the entrance processing section 303 sends an entrance request message containing the selected room ID, terminal identification number, nickname, and remark to the area chat management apparatus 1 via the transmission section 305. Regarding the remark and nickname, those stored in the status management section 310 may be used as they are.

5. The room allocation section 101 obtains the location of the appropriate chat room 110 based on the room ID contained in the entrance request message and with reference to the room data 121, acquires map data 120 of the area in which the chat room 110 exists from a map information server (not shown), and sends it to the new entrant 201. Besides, the room allocation section 101 forwards the entrance request message of the new entrant 201 to the log-in management section 111 of the appropriate chat room 110.

6. The location display section 315 of the terminal 3 accepts the received map data 120 via the analysis section 313 and displays it as background on the position indicator screen 32 of the display 30.

7. Upon receiving the new entrance request message, the log-in management section 111 of the chat room 110 prepares novel entrance information 130 based on the entrance request message. Also, the log-in management section 111 sends room properties 123 such as those shown in FIG. 6 to the terminal 3 of the new entrant 201.

8. On the terminal 3 of the new entrant 201, the room properties 123 received via the reception section 311 and process distribution section 312 is analyzed by the analysis section 313. While retaining the room ID, room location, terminal owner ID, participant IDs in the status management section 310, the terminal 3 sends the room title, the ID and location information of the terminal owner, and the participant IDs and location information of the other participants in location display section 315.

9. As shown in FIG. 2, the location display section 315 analyzes the location information of each participant ID and marks the other participants 43 by a black circle on the background map while displaying the room title 41 on the position indicator screen 32 of the display 30. Any participant whose location information indicates that he/she is located outside the area defined by the room location is marked by a black circle in the outsider pane 45. In this case, since the latest speaker in the chat is the terminal owner who is also the new entrant 201, the location of the terminal owner is indicated by a white star which is obtained by synthesizing the white mark indicating the terminal owner and the star indicating the latest speaker 44.

In this way, since the locations of the terminal owner, other participants, and latest speaker are indicated by different shapes and colors, the members participating in the chat room can be identified visually.

(b) Entrance Into a Chat Room at a Location, such as a Distant Place, Specified by the User

1. The process distribution section 302 accepts key entry (“specify a place for a room to enter” is selected) from 110 a user (new participant 201) who wants to participate in a chat room 110 set up at a specific location such as a distant place, via the key control section 301 on the terminal 3, and passes processing to the location specification section 304 via the entrance processing section 303.

2. The location specification section 304 displays a “specify a place” menu, allowing the new participant 201 to select what to use to specify a place: a station name, address, or phone number. Then it sends an entered search key (for example, station name) to the area chat management apparatus 1. Then, the room creation and location management section 102 of the area chat management apparatus 1 passes the accepted search key (station name) to the location specification section 105, acquires the latitude, longitude, and altitude of the specified place, prepares a room list 122 of the chat rooms 110 created and set up at appropriate locations, with reference to room data 121 and based on the acquired latitude, longitude, and altitude of the specified place, and sends it to the terminal 3. The entrance processing section 303 displays the accepted room list 122, makes the new participant 201 select a desired chat room 110, enter a nickname, select a Show/Hide Location setting, and enter the first remark to display, and then passes the nickname and Show/Hide Location setting to the status management section 310. Also, it prepares an entrance request message by attaching a terminal identification number; the nickname; the remark; the latitude, longitude, and altitude acquired in a manner similar to that used in the above process; a terminal identification number (cell phone number)—which is allocated uniquely to the terminal 3 by the common carrier—to the selected ID. Then, it sends the entrance request message to the area chat management apparatus 1 via the transmission section 305.

Subsequent processes are the same as those for entrance into a chat room set up at the current location of the user, and thus description thereof will be omitted.

(2) Creation of a Room and Notification to Push Subscribers

1. The process distribution section 302 accepts key entry (“create a room” is selected) from a user (room creator 202) who wants to create a chat room, via the key control section 301 on the terminal 3, and passes processing to the room creation section 308.

2. The room creation section 308 displays a menu, allowing the room creator 202 to select whether to create a chat room 110 at the current location or specify a place for a chat room 110 to be created. If the user selects “create a room at current location,” the room creation section 308 acquires the current location (latitude, longitude, and altitude) of the user from the GPS reception section 316 via the status management section 310. If the user selects “specify a place,” the room creation section 308 passes processing to the location specification section 304.

The location specification section 304 displays a “specify a place” menu, allowing the user to select a means of specification (a station name, address, or phone number) Then it sends data on the selection as well as an entered search key to the area chat management apparatus 1 via the transmission section 305.

The room creation and location management section 102 of the area chat management apparatus 1 acquires the latitude, longitude, and altitude of the specified place via the location specification section 105 and sends it to the room creation section 308 of the terminal.

3. The room creation section 308 allows the room creator 202 to enter a room title, a room location, a nickname, the first message to be displayed as well as to select whether to make his/her location public (Show/Hide Owner Location), whether to limit participants (Members-only/Open Membership), and whether to send push notification (Push Notification: Yes/No). The room creation section 308 prepares a room creation message from these data by adding the latitude, longitude, and altitude of the specified place received from the area chat management apparatus 1 and sends the message to the area chat management apparatus 1.

4. Upon receiving the room creation message, the room creation and location management section 102 of the area chat management apparatus 1 creates a chat room 110 based on the data contained in the room creation message. Then, it prepares room data 121 by adding a room ID to the room creation message data and manages the location of the chat room 110.

5. If the room creator 202 has selected Members-only in the process of 4 above, the room creation and location management section 102 checks with the member management section 104 on whether the area of the chat room 110 specified by the room creator 202 does not overlap even partially with any existing members-only chat room 110 managed by the member management section 104. If it is found by the member management section 104 that the area of the chat room to be created this time overlaps even partially with an existing members-only chat room 110, the room ID, room title, and list of participating members, managed by the member management section 104, are sent to the terminal 3 of the room creator 202. Then they are displayed on the terminal 3 to ask the room creator 202 to enter the existing chat room. Incidentally, the information about members-only rooms may be displayed in text-only form or map form. On the other hand, if there is no overlapping chat room 110, the room creation and location management section 102 creates a chat room 110 based on the room creation message.

6. If push notification is selected in the process of 4 above, the room creation and location management section 102 checks with the push management section 103 on whether there are users (push subscriber 203) who wants push notification within the area of the created chat room 110. If the push management section 103 finds that there are push subscribers 203, it sends the push subscribers 203 push information consisting of the room ID of the chat room 110 created by the room creator 202 and the first message to be displayed.

(3) Registration of Push Notification

1. The process distribution section 302 accepts key entry (“subscribe to push notification” is selected) from a user (push subscriber 203) who wants to subscribe to push notification, via the key control section 301 on the terminal 3, and passes processing to the push notification section 309.

2. The push notification section 309 allows the push subscriber 203 to select whether he/she wants to be notified when a chat room 110 is created around his/her location (for example, within a 3-km radius around his/her location) (real area push) or when a chat room 110 is created around a place specified in advance (for example, within a 3-km radius around Shibuya Station) (specified-area push). The push notification section 309 sends a push notification subscriber message containing the terminal identification number of the push subscriber 203 and the type of push notification selected (real area push or specified-area push) to the area chat management apparatus 1. If specified-area push is selected in the push notification subscriber message, the push notification section 309 makes the location specification section 304 specify a place and sends the push notification subscriber message by including the specified place. The push management section 103 of the area chat management apparatus 1 registers and retains the accepted push notification subscriber message.

3. If real area push is selected in the process of 2 above, the push notification section 309 asks the location information update section 307 to make location information update notification. The location information update section 307 sends the location (latitude, longitude, and altitude) of the push subscriber 203 acquired from the GPS reception section 316 via the status management section 310 to the area chat management apparatus 1 at regular intervals or upon termination of incoming/outgoing mail or a call. The push management section 103 of the area chat management apparatus 1 manages the current location of the user together with the user information contained in the push notification subscriber message of the push subscriber 203. On the other hand, if specified-area push is selected, the push management section 103 passes the specified place contained in the push notification subscriber message to the location specification section 105, acquires the latitude, longitude, and altitude of the specified place, and manages it together with the user information.

4. Once the chat room is created by the processing method described above in “(2) Creation of a room and notification to push subscribers,” the push management section 103 delivers push information to the appropriate push subscriber 203 and prompts him/her to enter the chat room 110 created.

(4) Registration of Specified-Creator Push Notification

1. Suppose a push subscriber 203 wants to receive push notification if a members-only chat room 110 is created by a member of a group to which the push subscriber 203 belongs. The process distribution section 302 accepts key entry (“subscribe to push notification by specifying a creator” is selected) from the user via the key control section 301 on the terminal 3, and passes processing to the push notification section 309.

2. The push notification section 309 sends a specified-creator push notification subscriber message containing the terminal identification number of the terminal 3 of the push subscriber 203 to the area chat management apparatus 1. Furthermore, in the case when any message for the room creator 202 is inputted from the push subscriber 203, the specified-creator push notification subscriber message together with the message for the room creator 202 is sent to the area chat management apparatus 1. The member management section 104 of the area chat management apparatus 1 registers the user information contained in the specified-creator push notification subscriber message of the push subscriber 203 and retains the message addressed to the room creator 202.

3. When running processing based on a members-only room creation message received from a member (the room creator 202) of a group to which the push subscriber 203 belongs, the room creation and location management section 102 makes an inquiry with the member management section 104. If specified-creator push notification has been subscribed to, the member management section 104 sends the message addressed to the room creator 202 and held in trust for the push subscriber 203 to the room creator 202 himself/herself as well as sends push information about the room creator 202 to the push subscriber 203.

4. If the terminal 3 of the push subscriber 203 logs in to the chat room 110 upon receiving the notification, map data 120 for the area of the chat room 110 as well as room properties 123 are downloaded.

(5) Entrance Notification to Other Participants

1. Upon receiving the entrance request message of the new participant 201 from the room allocation section 101, the log-in management section 111 of the chat room 110 prepares novel entrance information 130 such as the one shown in FIG. 7, based on the entrance request message, and sends it to existing participants 205 to 207 of the chat room 110.

2. On the terminals 3 of the participants 205, 206, 207, etc., the analysis section 313 analyzes the novel entrance information 130 received and the status management section 310 merges the novel entrance information 130 with the room properties 123 retained by the area chat management apparatus 1. If the novel entrance information 130 contains location information, the analysis section 313 sends the IDs and location information of the participants to the location display section 315.

3. The location display section 315 analyzes the location information of the new participant 201 and indicates the location of the new participant 201 on the map in the position indicator screen 32 of the display 30 by a distinctive shape, color, or the like so that it can be distinguished from the locations of the other participants.

4. If the novel entrance information 130 contains a remark of the new participant 201, the analysis section 313 sends his/her nickname and remark to the message display section 314, which then displays the nickname and remark (message) on the chat display screen 31 of the display 30.

(6) Remark permission request and remark notification

1. When a user (speaker 204) who is already in the chat room 110 makes a new remark, the remark processing section 306 of the terminal 3 receives the remark via the key control section 301 and process distribution section 302. The remark processing section 306 prepares a remark message using the room ID, the ID and nickname of the speaker 204 who is the terminal owner, the terminal identification number, the location information (latitude, longitude, and altitude) updated by the GPS reception section 316, and the entered remark, with reference to the room properties 123 retained by the status management section 310. The transmission section 305 sends there mark message to the a reach at management apparatus 1.

2. Upon receiving the remark message, the remark acceptance section 106 of the area chat management apparatus 1 forwards the remark message to the appropriate chat room 110 according to the room ID contained in the remark message.

3. Upon receiving the remark message, the log-in management section 111 of the chat room 110 prepares remark information 131 such as the one shown in FIG. 8 and sends it to the participants 205, 206, and 207 and the speaker 204 of the chat room 110.

4. On the terminals 3 of the participants 205, 206, and 207 and the speaker 204, the analysis section 313 analyzes the remark information 131. Based on the data passed by the analysis section 313, the status management section 310 updates the location information and the latest update time of the appropriate participants in the room properties 123 it retains. The analysis section 313 sends the participant ID and location information of the speaker 204 to the location display section 315.

5. The location display section 315 analyzes the acquired location information, updates the current display position associated with the participant ID of the 204 speaker to new display position, and indicates the position by the mark of the latest speaker 44 as shown in FIG. 2. Besides, the mark of the previous speaker (latest speaker 44) is changed to the mark which indicates another speaker 43.

In this way, each time anew remark is made, the latest speaker is indicated by a mark shaped or colored in such a way that he/she can be distinguished from other participants. This makes it possible to tell at a glance who is making a remark.

(7) Settings for Dynamic Delivery of Location Information

1. The process distribution section 302 accepts key entry (“make settings for delivery of location information” is selected) from a user who wants dynamic delivery of location information, via the key control section 301 on the terminal 3, and passes processing to the location information update section 307.

2. The location information update section 307 displays a menu, prompting the user to enter an update interval of location information or specify an occasion on which location information should be updated, such as upon termination of incoming/outgoing mail or a call.

3. The location information update section 307 registers the interval or occasion specified by the user and makes the status management section 310 acquire location information (latitude, longitude, and altitude) from the GPS reception section 316 at the specified intervals or on the specified occasion.

4. The location information update section 307 sends location update information 320 shown in FIG. 11, including the acquired location information, to the area chat management apparatus 1.

5. If the user is chatting, i.e., if the user is in the chat room 110, the remark acceptance section 106 of the area chat management apparatus 1 forwards the location update information 320 to the log-in management section 111 of the appropriate chat room 110 with reference to the room ID contained in the location update information 320 received. The log-in management section 111 sends the location update information 320 to the terminals 3 of the other participants via the transmission section 113. Also, it updates the location information and the latest update time of the appropriate participants in the room properties 123.

6. If the user is a push subscriber, the location information in the location update information 320 received by the area chat management apparatus 1 is passed to the push management section 103, which then updates the location information in the user information of the push subscriber 203.

(8) Exit Processing

1. The log-in management section 111 sends a connection check signal periodically to the terminals 3 of the participants of its own chat room 110 to check whether connection is maintained. If an exit item or exit key is selected on the terminal 3 of a participant, breaking the connection, or if it is found that no event is taking place in any processing section of the terminal 3 polled by the area chat management apparatus 1, the log-in management section 111 considers that the participant has exited the chat room 110 and sends exit information 132 such as the one shown in FIG. 9 to the other participants.

2. On the terminals 3 of the participants 204, 205, 206, 207, etc., the analysis section 313 analyzes the exit information 132. The status management section 310 removes the ID, location information, and latest update time of the participant regarded to have exited the room, from the room properties 123 it retains. The message display section 314 displays an exit message on the chat display screen 31 while the location display section 315 erases the location mark associated with the participant ID of the participant who has exited the room, from the position indicator screen 32.

(9) Location Search

In addition to the above processes, the system which implements the present invention is capable of performing searches for locations of past remarks. In that case, the process distribution section 302 provides a Search menu item or Search key on the display 30. Besides, the analysis section 313 retains history of remark information.

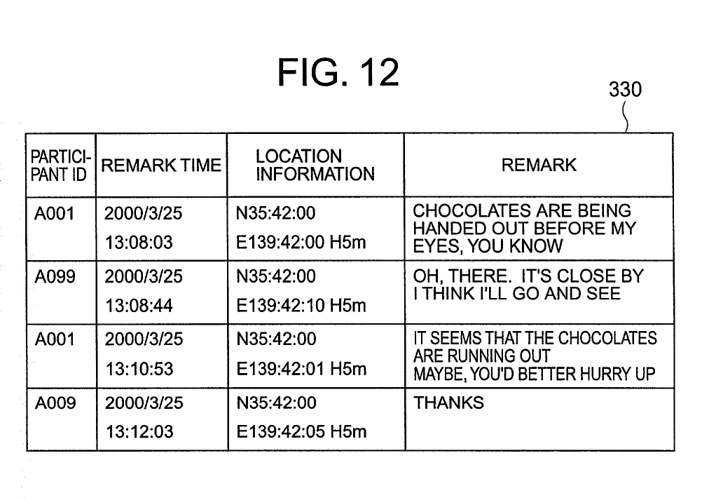

1. The analysis section 313 of the terminal 3 records a chat log by receiving remark information 131 from the area chat management apparatus 1. FIG. 12 shows a data configuration example of a chat log record 330. The chat log record 330 contains speakers' participant IDs, the time at which remarks were made, location information, and remarks.

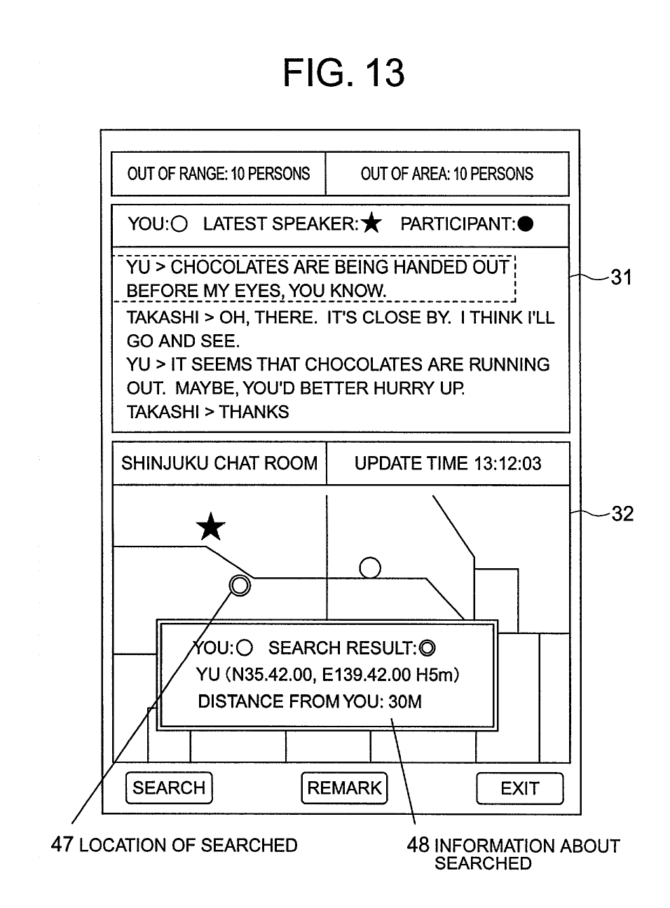

2. A user who wants to search for the location where a remark was made positions the cursor on the desired remark (the one with the dotted box around it in FIG. 13) in the chat display screen 31 and then selects Search. The analysis section 313 extracts the specified remark from the chat log record 330 and indicates the retrieved location of the speaker at the time of the remark, for example, by a double circle on the map in the position indicator screen 32.

Furthermore, the analysis section 313 calculates the distance between the location at the time of the remark retrieved from the chat log record 330 and the current location of the terminal owner acquired by the GPS reception section 316 and displays it as search information 48 on the display 30.

Thus, by specifying a remark directly, users can find out easily where the remark was made, including not only the latest remark, but also a past remark in the chat, such as “Chocolates are being handed out before my eyes, you know.”

In addition to the above processes, the system which implements the present invention is capable of acquiring the current location of a participant based on a remark on the chat display screen 31 or a mark on the position indicator screen 32. In that case, the process distribution section 302 provides a Location Inquiry menu item on the display 30.

1. A user who wants to inquire about the current location of a participant specifies the remark or mark of the desired participant on the display 30 by a cursor or the like and then selects the Location Inquiry menu item. The analysis section 313 extracts the speaker ID associated with the specified remark and asks the area chat management apparatus 1 for location information.

2. The area chat management apparatus 1 asks the terminal 3 with the participant ID of the searched participant whether it permits its location information to be made public. If the terminal 3 of the searched participant permits its location information to be made public, it sends its current location acquired by the GPS reception section 316 to the area chat management apparatus 1.

If the location information acquired from the terminal 3 of the searched participant indicates a location outside the area of the chat room 110, the area chat management apparatus 1 sends map data 120 and location information around the location of the searched participant to the terminal 3 of the searcher. On the other hand, if the location of the searched participant is within the area of the chat room 110, the area chat management apparatus 1 sends only the location information of the searched participant. The terminal 3 of the searcher displays the received location information on the position indicator screen 32 or displays the latitude, longitude, and altitude in text form.

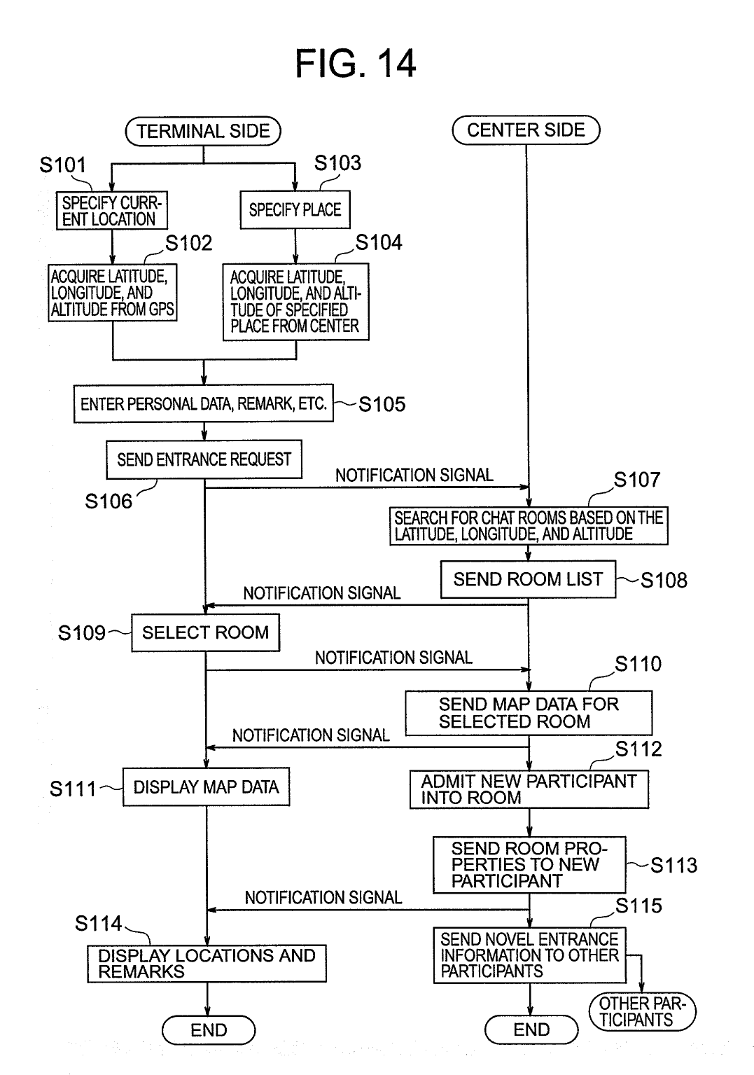

FIGS. 14 to 19 show flows of various processes according to the present invention.

FIG. 14 is a processing flowchart of room entrance processes. If the user (new participant 201) specifies the current location in an entrance request (Step S101), current location information (latitude, longitude, and altitude) is acquired from GPS (Step S102). If the user specifies any other place (Step S103), the latitude, longitude, and altitude of the specified place are acquired from the area chat management apparatus 1 (hereinafter referred to as “the center 1”) (Step S104). Besides, the terminal 3 sends an entrance request message to the center 1 (Step S106) based on data, such as personal data and a remark entered by the user using input means such as keys (Step S105). In response, the center 1 searches for chat rooms 110 based on the latitude, longitude, and altitude contained in the entrance request message (Step S107), creates a room list 122, and sends it to the terminal (Step S108). The terminal 3 displays the room list 122, allowing the user to select a desired chat room 110, and notifies the center 1 of the selected chat room 110 (Step S109). The center 1 acquires map data 120 for the selected chat room 110 and sends it to the terminal 3 (Step S110). The terminal 3 displays the map data 120 as background on the position indicator screen 32 of the display 30 (Step S111). The center 1 admits the new participant 201 into the chat room 110 (Step S112) and sends room properties 123 containing the IDs and location information of other participants, etc. to the terminal 3 of the new participant 201 (Step S113). The terminal 3 analyzes the received room properties 123 and displays the locations and remarks of the other participants on the display 30 (Step S114). The center 1 sends novel entrance information 130 consisting of the location information, remark, etc. of the new participant 201 to the terminals 3 of the other participants 205 to 207 (Step S115).

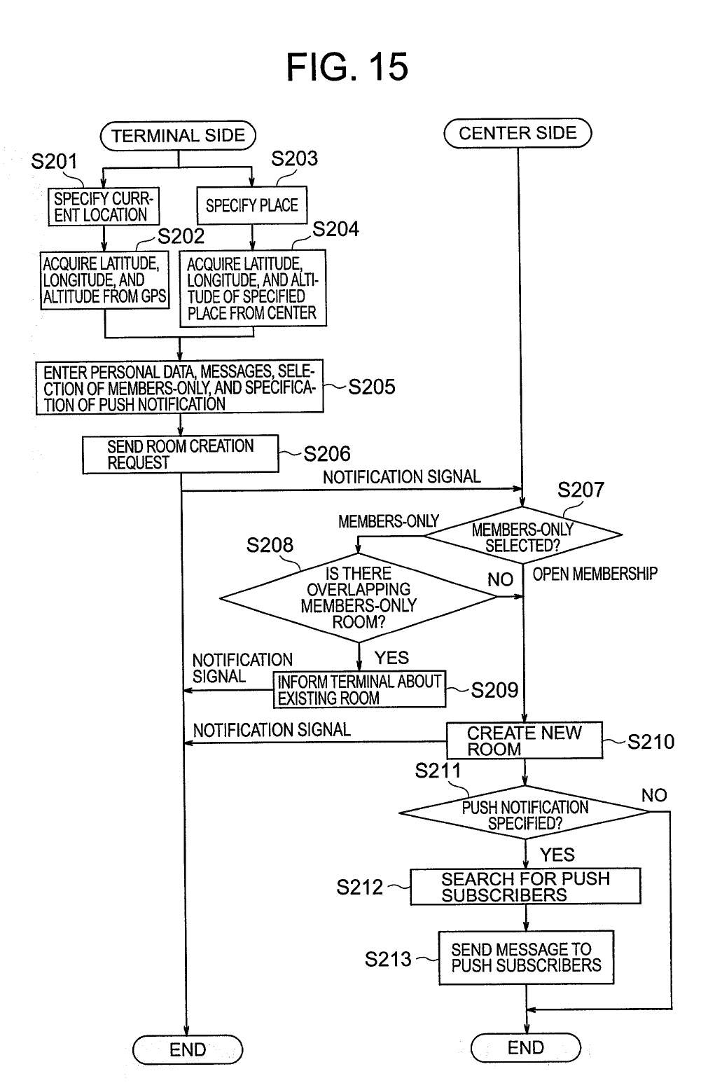

FIG. 15 is a processing flowchart of room creation processes. If a user (room creator 202) specifies the current location when creating a chat room (Step S201), current location information (latitude, longitude, and altitude) is acquired from GPS (Step S202). If the user specifies any other place (Step S203), the latitude, longitude, and altitude of the specified place are acquired from the center 1 (Step S204). Besides, the terminal 3 sends a room creation request message to the center 1 (Step S206) based on data, such as personal data, messages, selection of Members-only, and specification of push notification, entered by the user using input means such as keys (Step S205). Based on the room creation request message, the center 1 judges whether Members-only is selected, i.e., which is selected, Members-only or Open Membership (Step S207). If Members-only is selected, the center 1 judges whether there is an existing members-only chat room whose area overlaps with that of the chat room to be created this time (Step S208). If there is an overlapping chat room 110, information about it is sent to the terminal 3 (Step S209). If the chat room to be created is of the open membership type or if there is no overlapping chat room 110, a chat room 110 is created anew (Step S210). Furthermore, the center 1 judges whether push notification has been specified (Step S211). If push notification has been specified, the center 1 searches for appropriate push subscribers (Step S212) and sends a message from the room creator to the retrieved push subscribers (Step S213).

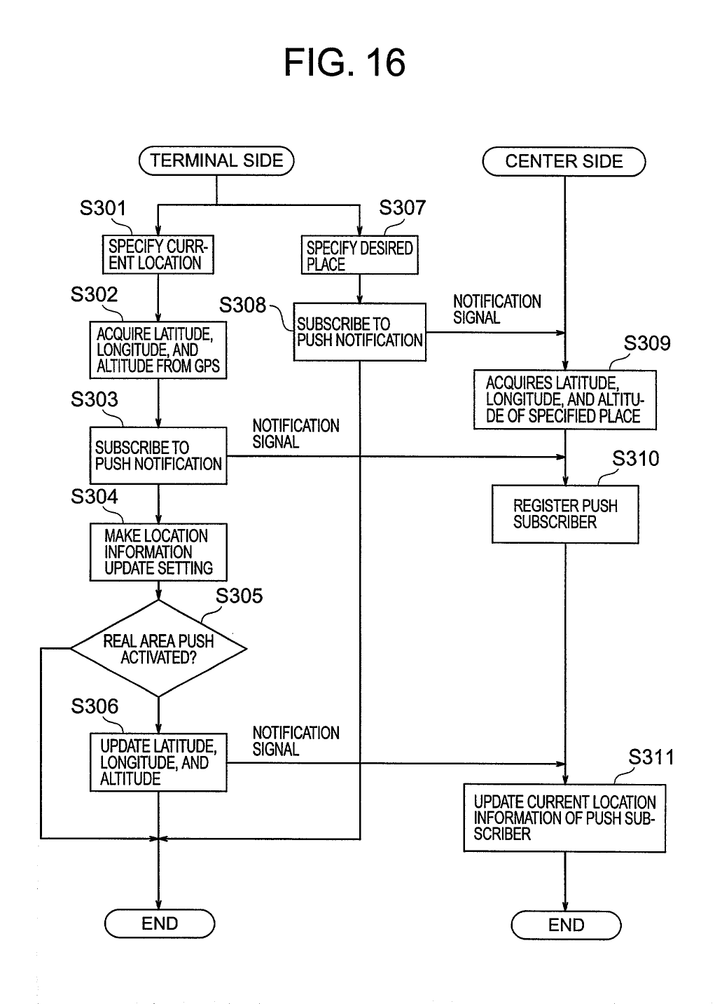

FIG. 16 is a processing flow chart of push notification setting processes. If a user (push subscriber 203) specifies the current location (Step S301) when subscribing to push notification, the terminal 3 acquires current location information (latitude, longitude, and altitude) from GPS (Step S302), sends a push notification subscriber message to the center 1 with the current location information attached (Step S303), and specifies the interval or occasion for location information update (Step S304). The center 1 registers the push subscriber 203 and retains registration data and the latitude, longitude, and altitude of the push subscriber 203 (Step S310). Later, when real area push is activated (Step S305), the terminal 3 acquires current location information from GPS and sends location update information 320 to the center 1 (Step S306). The center 1 updates the current location information of the appropriate push subscriber 203 (Step S311). On the other hand, if the user specifies any desired place when subscribing to push notification (Step S307), the terminal 3 sends the center 1 a push registration message with the specified place attached (Step S308). Upon receiving the push notification subscriber message with the specified place attached, the center 1 acquires the latitude, longitude, and altitude of the specified place (Step S309), registers the push subscriber 203, and retains the registration data of the push subscriber 203 and the latitude, longitude, and altitude of the specified place (Step S310).

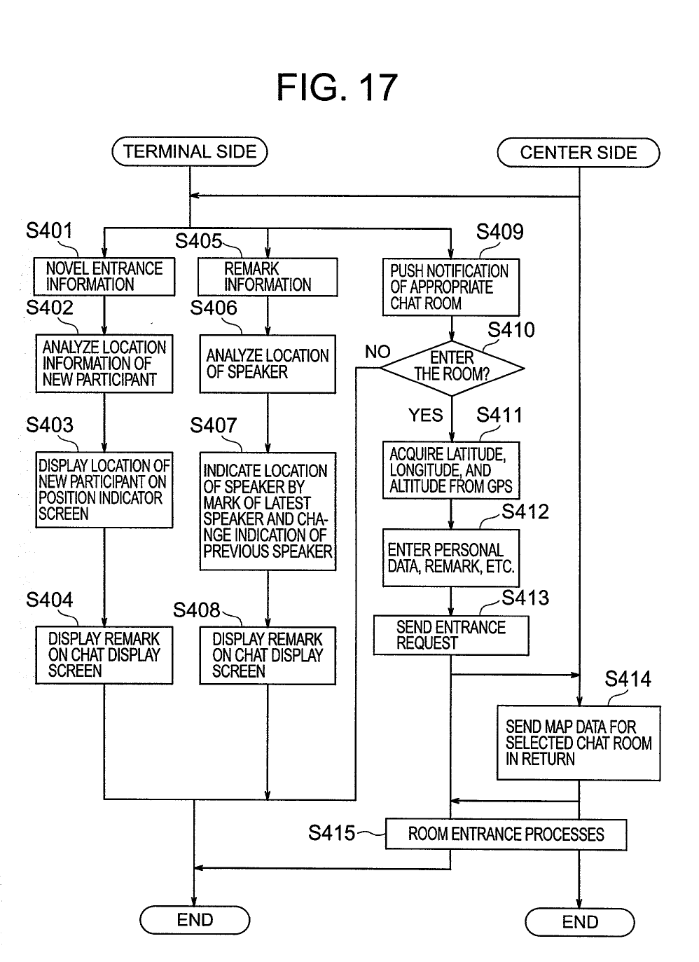

FIG. 17 is a processing flowchart of information receiving processes on the side of the terminal 3. If the information received from the center 1 is novel entrance information 130 (Step S401), the terminal 3 analyzes the location information of the new participant 201 contained in the novel entrance information 130 (Step S402), displays the mark of a new participant at the appropriate location on the position indicator screen 32 (Step S403), and displays the remark on the chat display screen 31 (Step S404). If the information received from the center 1 is remark information 131 (Step S405), the terminal 3 analyzes the location of the 204 speaker using the remark information 131 (Step S406), displays the mark of the latest speaker by updating the location of the appropriate speaker 204 on the position indicator screen 32, changes the indication of the previous speaker (Step S407), and displays the remark on the chat display screen 31 (Step S408). The display processing of the latest speaker will be described later. If the information received from the center 1 is push notification of an appropriate chat room 110 (Step S409) and if the user intends to enter the chat room 110 (Step S410), the terminal 3 acquires the latitude, longitude, and altitude from GPS (Step S411), enters personal data, a remark, etc. (Step S412), and sends an entrance request message to the center 1 (Step S413). Upon receiving the entrance request message, the center 1 sends map data 120 for the selected chat room 110 to the terminal 3 (Step S414). Then, the same processes as the processes of Step S111 and subsequent steps shown in FIG. 14 are performed as room entrance processes (Step S415).

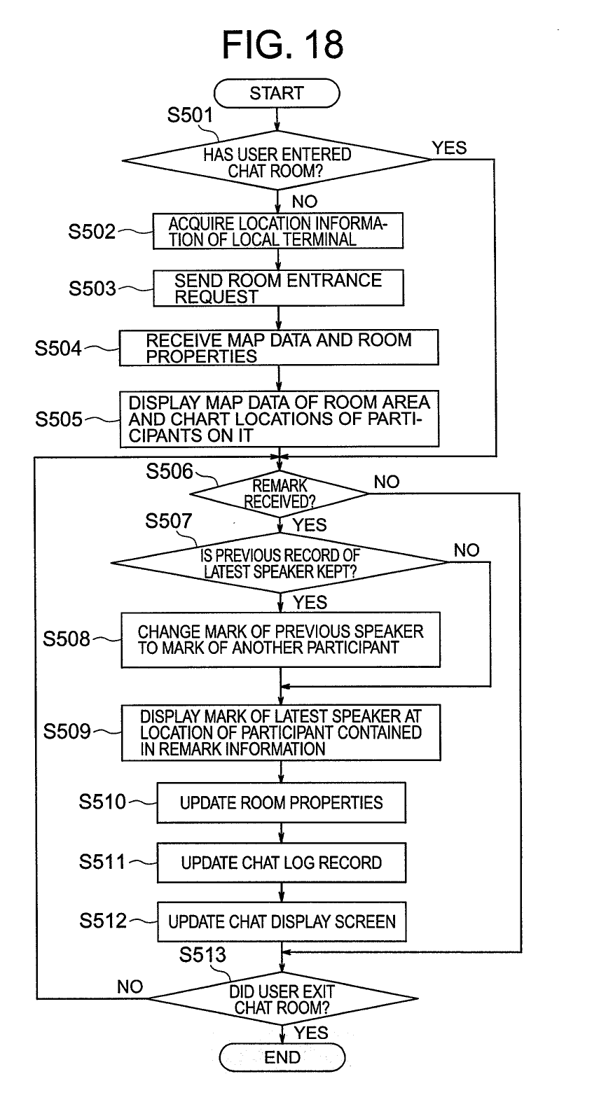

FIG. 18 is a processing flowchart of display processes for the latest speaker. If the user has not entered a chat room 110 yet (Step S501), the terminal 3 acquires the location information of itself (Step S502), sends a room entrance request message to the center 1 (Step S503), and receives map data 120 and room properties 123 from the center 1 (Step S504). The terminal 3 displays the map data 120 of the chat room 110 area and charts the locations of the participants on the position indicator screen 32 (Step S505). Then, when remark information 131 is received (Step S506), the terminal 3 checks whether a previous record of the latest speaker is kept (Step S507). If the previous speaker record is kept, the terminal 3 changes the mark of the latest speaker at the location of the previous speaker to the mark of another participant (Step S508), displays the mark of the latest speaker at the location of the participant contained in the remark information 131 received (Step S509), and updates the location information and latest update time for the appropriate participant in the room properties 123 (Step S510) Furthermore, the terminal 3 updates the chat log record 330 (Step S511) and displays the new remark on the chat display screen 31 (Step S512). The terminal 3 repeats Step S506 and subsequent processes until the user exits the chat room 110 (Step S513).

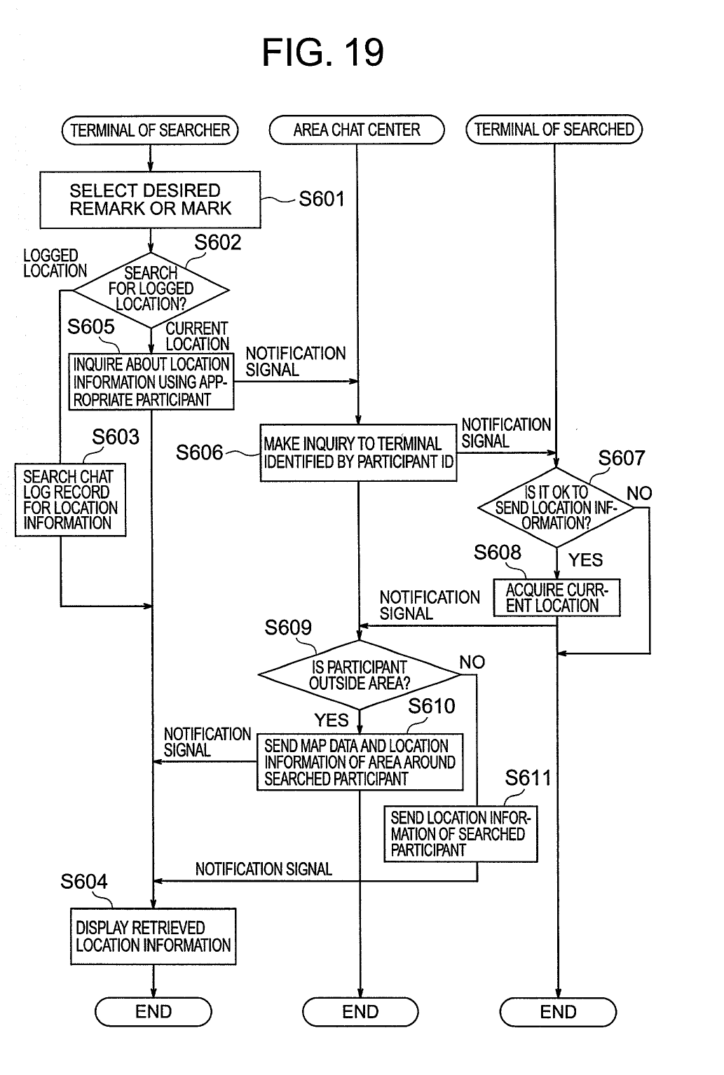

FIG. 19 shows a processing flowchart of participant location search processes. First, the user selects a desired remark or mark (Step S601). If the user wants to search for the location (logged location) of a past remark (Step S602), the chat log record 330 is searched for location information of the given remark or mark (Step S603) and the retrieved location information is displayed (Step S604).

On the other hand, if the user wants to search for (inquire about) a current location (Step S602), the terminal 3 extracts the appropriate participant ID from the room properties 123 and asks the center 1 for location information (Step S605). The center 1 asks the terminal 3 of the searched participant identified by the participant ID whether it permits answering the inquiry about location information (Step S606). If the terminal 3 of the searched participant permits sending its location information (Step S607), it acquires its current location via GPS and sends it to the center 1 (Step S608). The center 1 checks whether the location acquired from the terminal 3 of the searched participant is outside the area of the chat room 110 (Step S609). If it is outside the area of the chat room 110, the center 1 sends map data 120 and location information of the area around the searched participant to the terminal 3 of the searcher (Step S610). If the searched-for location is within the area of the chat room 110, the center 1 sends location information of the searched participant (Step S611). The terminal 3 of the searcher displays the received location information or the map data 120 and location information of the surrounding area (Step S604).

Now application examples of the present invention will be described below.

(1) First Application Example

A first application example shows how application of the present invention improves the effectiveness of commercial advertisement.

Suppose user A located in Shinjuku has subscribed to real area push in order to be notified if a chat room is set up at his location (Shinjuku). Also, it is assumed that another user B located in Shinjuku has subscribed to specified-area push by selecting the Shinjuku area. Besides, it is also assumed that user C located in Shibuya has subscribed to specified-area push by selecting the Shinjuku area.

The owner D of a restaurant in Shinjuku plans a limited special offer of a new set meal beginning at 11:30. At 11:30, the restaurant owner D accesses the center 1 and creates a chat room 110 by specifying an area within an N-km radius around the restaurant. He posts advertisement of the limited special offer as the first message to be conveyed to the entrants.

The center 1 receives the remark message of the restaurant owner D, notifies appropriate push subscribers—userA, userB, and user C—about the room created by the restaurant owner D, and sends them the advertising remark message.

Users A and C, who are hungry just then because it is lunch time, feel interested in the advertisement and log in to the chat. User B, who is not much interested, but is free, also logs in to the chat. Consequently, the locations of the restaurant owner D, user A, user B, and user C are displayed on their terminals 3. User A can tell the location of the restaurant because the location of the restaurant owner D, who is the latest speaker, blinks as he makes a remark. User A has his appetite for consumption increased because he knows that the restaurant is located close to him (within N kilometers). User C, who is located in Shibuya, asks through the chat about details of the new meal, know how to get to the eating house, and how crowded it is, and gets answers immediately from the restaurant owner D through the chat. Consequently, he has his appetite stimulated, decides to go to Shinjuku, and reserves a seat through the chat. User B, who was not interested in the new menu, has his appetite stimulated as he observes user C and the restaurant owner D chat with each other, and decides to go to the restaurant.

In this way, a chat room of the present invention allows shop owners to send an effective advertisement in a timely manner, leading directly to consumption. Since this method uses a relatively small terminal such as a cell phone, even the owners of relatively small shops can send information easily. Besides, consumers can selectively receive advertisements fresh in time and close in space or receive information about places of interest by specifying the places from a distant location, resulting in improved convenience for consumer activities.

(2) Second Application Example

A second application example shows how application of the present invention improves flexibility in exchanging communications among people who have arranged to meet.

Suppose college alumni A, B, C, and D plan to hold a year-end party. Since they could not reserve a place, they arranged to meet in Ginza at 19 o'clock on the day of the party. At around 18:30, A, who arrives in Ginza first, accesses the center 1 and creates a members-only chat room 110. Since no one has logged in yet, he makes a remark “I'll go and look for a place.” Then he goes looking for an eating house, but he just cannot make a reservation because every eating house are full in this season of year-end parties. B, who arrives in Ginza at 18:50, attempts to set up a members-only chat room 110, but learns that one has already been set up by A. He sees from the blinking mark and remark of the latest speaker that A is looking for a restaurant. B communicates with A through a chat and learns that no place has been secured yet. A and B can locate each other on the screen by looking at the blinking mark of the latest speaker which changes places each time they make a remark. Also, they can communicate other matters through the chat. B continues to look for a restaurant at some distance from A while checking the whereabouts of A on the screen. Then, B finds a restaurant with vacant seats and mentions it through the chat. Looking at B's message, A says in the chat that he is coming to B's location.

C arrives later and logs in to the chat room 110. He understands the circumstances by reading the chat between A and B and mentions in the chat that he is coming to B's location, which is blinking as the location of the latest speaker. On the other hand, D, who is having difficulty finishing his work and still cannot go to Ginza, attempts to create a chat room 110 from another point. However, he learns that a chat room 110 has already been set up by A, logs in to it, and remarks that he will be a little late. As C and D make remarks, A and B can easily grasp the situation and identify C and D's locations, and thus can order dishes with precise timing.

In this way, when people arrange to meet as a group, the use of a chat service associated with locations allows them to wait for one another flexibly. Consequently each member can spend his/her time effectively. Since the location of each user is automatically indicated on the display 30 when he/she makes a remark, he/she does not need to make his/her whereabouts (location) known using a message. This makes it possible to convey information efficiently.

(3) Third Application Example

A third application example shows how the present invention improves the timeliness and reliability in delivery of regional information.

Being driven by a desire to see some movies, a movie fan A goes to Shinjuku which abounds in movie theaters, without making particular preliminary checks. Upon arrival in Shinjuku, A accesses the center 1 and makes a novel entrance request by specifying the current location (Shinjuku). The center 1 determines that A is in the Shinjuku area and makes A log in to a chat room 110. A makes a remark in the chat room 110: “Are there any interesting movies?” B, who happens to pass in front of movie theater X tells A in the chat about the film which is showing and its next starting time. Since B's remark is displayed with his location blinking on A's portable terminal, A sees the approximate location of movie theater X in addition to obtaining information about the movie. Another participant D of the same chat room 110 reads the chat between A and B, remembers that he has a complimentary ticket for the movie, and tells A in the chat that he will give it to him. Since the participants of a chat room 110 are located in the same area they can convey information in a timely manner. Also, they can give or receive any incidental article easily because they can identify each other's locations.

In this way, users who are located at a short distance from one another, but are not acquainted with one another can communicate common information in terms of time and place. Furthermore, since they can identify each other's locations, they can estimate the reliability of the information.

(4) Fourth Application Example

A fourth application example shows how the present invention improves the flexibility and convenience in allocation of business opportunities.

Suppose forwarding agents A, B, C, and D and shippers E, F, J, and H have tied up in transportation business to form a joint transportation group. The group plans to engage in commissioning and undertaking of transportation services using the members-only function and specified-creator push notification function provided by the center 1. Forwarding agents A, B, C, and D subscribe to push notification so that the center 1 will send notification if any of the group members makes a remark. Their advertisements and coupon information are to be sent as messages to room creators when chat rooms 110 are created. Shipper E that is to ship goods to a local customer who runs a store sets up members-only (joint transportation group) chat room 110. Shipper E receives the advertisements and coupon information entrusted to the center 1 by forwarding agents A, B, C, and D. At the same time, forwarding agents A, B, C, and D are notified that shipper E has created a chat room 110 (which means that there will be a request for transportation). As forwarding agents A, B, C, and D log in to the chat room 110, they learn the location of shipper E Forwarding agents A and B that are located near shipper E want to get an order and make a remark addressed to shipper E. Based on the advertisements and coupon information conveyed first as well as on price negotiation through a chat, shipper E decides to entrust forwarding agent A with the transportation and makes a remark to that effect in the chat. This capability to exchange remarks and location information whenever necessary makes it possible to allocate business opportunities smoothly.

The present invention has been described above, with reference to some of its implementations, but various modifications can be made within the spirit and scope of the present invention. For example, although according to an embodiment of the present invention, the terminal 3 updates the room properties 123 it retains by merging them with information received from the area chat management apparatus 1, the log-in management section 111 of the area chat management apparatus may update the room properties 123 based on provided information and send the updated room properties 123 to the terminal 3 in return for the provided information.

The present invention provides communications means for handling location information and remark messages simultaneously. The capability to identify the real locations of remarks made in a chat room gives more sense of reality to the conversations in the chat room than conversations in conventional chat rooms, resulting in increased reliability of the conversations. In particular, communications can be carried out smoothly among friends who have arranged to meet or any information associated with a location can be shared among strangers.

Also, the capability to use chat messages for advertisement allows relatively small stores to use community-based advertisements. Besides, the push notification capability makes it possible to dispatch business on a timely basis.

What is claimed is:

1. A method for providing area chat rooms where unspecified users each carrying a portable terminal can exchange character information or the like in real time, the method comprising the steps of:
managing access to area chat rooms each associated with a specific location;
accepting an entrance request, with the current location of the terminal or a user-specified location attached, from said terminal for permission to enter one of said area chat rooms, and allowing entrance into any appropriate area chat room whose area includes said current location or specified location;
accepting a remark request, with the current location of the terminal attached, from said terminal for permission to make a remark, and delivering the remark to the terminals of the other participants of said area chat room by attaching the location of said terminal; and
accepting location update information from said terminal and delivering said location update information to the terminals of the other participants of said area chat room.

2. A method for providing area chat rooms according to claim 1, further comprising:
accepting any inquiry about the current location of another participant in the area chat room from said terminal, acquiring the current location from the terminal of said other participant if the terminal of said other participant permits sending a reply, and sending the current location of said other participant in return.

3. A method for providing area chat rooms according to claim 1, further comprising:
creating an area chat room by specifying a range based on the current location of said terminal or a user-specified location if a request to create an area chat room is received from said terminal.

4. A method for providing area chat rooms according to claim 1, further comprising:
registering and managing information about any subscriber who wants to be notified if an area chat room whose area includes the current location of the terminal or a user-specified location is created; and
notifying said subscriber's terminal about creation of any area chat room which agrees with the information about said subscriber.

5. A terminal-side area chat processing method for use in a system which provides chat rooms where unspecified users each carrying a portable terminal can exchange character information or the like in real time, the method comprising the steps of:
sending a server of said system an entrance request with the current location of the terminal or a user-specified location attached, requesting for permission to enter an area chat room provided by said system and associated with a specific location;
sending the server of said system a remark request, with the current location of said terminal attached, when the user is in said area chat room;
receiving the current locations and remarks of all the participants as well as map data corresponding to the range of said area chat room from said system and displaying said map data, charted locations of the participants, and remarks of the participants on a display screen of said terminal when the user is in said area chat room; and
informing the server of said system about the current location of said terminal at designated intervals or on designated occasions.

6. A terminal-side area chat processing method according to claim 5, wherein said entrance request contains direction whether or not the current location attached to said entrance request is to be shown to other participants.

7. A terminal-side area chat processing method according to claim 5, wherein the charted location of the latest speaker is indicated by a shape, color, or method different from those for other speakers when charting the locations of the participants who are in said area chat room.

8. A terminal-side area chat processing method according to claim 5, wherein the charted location of the local terminal is indicated by a shape, color, or method different from those for the other participants when charting the locations of the participants who are in said area chat room.

9. A terminal-side area chat processing method according to claim 5, further comprising:
retaining the time and location of each received remark, accepting a remark location search request to search for the location of a specific remark displayed on the display screen of said terminal, and charting the location where said remark was made, using a shape, color, or method different from those for the locations of the other participants.

10. A terminal-side area chat processing method according to claim 9, wherein, after accepting a remark location search request, calculating the distance between the location at the time of said remark and the current location of the terminal and displaying it on the display of said terminal.

11. A terminal-side area chat processing method according to claim 5, further comprising: sending said system a room creation request to create an area chat room with its range specified based on the current location of said terminal or a user-specified location.

12. A terminal-side area chat processing method according to claim 11, wherein said room creation request contains information to limit the participants who are allowed in the area chat room created.

13. A computer-readable medium for recording a processing program to provide area chat rooms where unspecified users each carrying a portable terminal can exchange character information or the like in real time, wherein the program causes a computer execute:
managing access to area chat rooms each associated with a specific location;
accepting an entrance request, with the current location of the terminal or a user-specified location attached, from said terminal for permission to enter one of said area chat rooms, and allowing entrance into any appropriate area chat room whose area includes said current location or specified location;
accepting a remark request, with the current location of the terminal attached, from said terminal for permission to make a remark, and delivering the remark to the terminals of the other participants of said area chat room by attaching the location of said terminal; and
accepting location update information from said terminal and delivering said location update information to the terminals of the other participants of said area chat room.

14. An apparatus for providing area chat rooms where unspecified users each carrying a portable terminal can exchange character information or the like in real time, the apparatus comprising:
room log-in management means for managing access to area chat rooms each associated with a specific location;
entrance processing means for accepting an entrance request, with the current location of the terminal or a user-specified location attached, from said terminal for permission to enter one of said area chat rooms, and allowing entrance into any appropriate area chat room whose area includes said current location or specified location;
remark accepting means for accepting a remark request, with the current location of the terminal attached, from said terminal for permission to make a remark, and delivering the remark to the terminals of the other participants of said area chat room by attaching the location of said terminal; and
location-update information delivery means for accepting location update information from said terminal and delivering said location update information to the terminals of the other participants of said area chat room.

15. An apparatus according to claim 14, further comprising:
current location inquiry processing means for accepting any inquiry about the current location of another participant in the area chat room from said terminal, acquiring the current location from the terminal of said other participant if the terminal of said other participant permits sending a reply, and sending the current location of said other participant in return.

16. An apparatus according to claim 14, further comprising:
room creation processing means for creating an area chat room by specifying a range based on the current location of said terminal or a user-specified location if a request to create an area chat room is received from said terminal.

17. An apparatus according to claim 14, further comprising:
push subscription processing means for registering and managing information about any subscriber who wants to be notified if an area chat room whose area includes the current location of the terminal or a user-specified location is created; and
push notification processing means for notifying said subscriber's terminal about creation of any area chat room which agrees with the information about said subscriber.

18. A terminal-side apparatus for use in a system to provide area chat rooms, the system provides chat rooms where unspecified users each carrying a portable terminal can exchange character information or the like in real time, the apparatus comprising:
entrance processing means for sending a server of said system an entrance request with the current location of the terminal or a user-specified location attached, requesting for permission to enter an area chat room provided by said system and associated with a specific location;
remark processing means for sending the server of said system a remark request, with the current location of said terminal attached, when the user is in said area chat room;
display processing means for receiving the current locations and remarks of all the participants as well as map data corresponding to the range of said area chat room from said system and displaying said map data, charted locations of the participants, and remarks of the participants on a display screen of said terminal when the user is in said area chat room; and
location information update processing means for informing the server of said system about the current location of said terminal at designated intervals or on designated occasions.

19. A terminal-side apparatus according to claim 18, wherein said entrance request contains direction whether or not the current location attached to said entrance request is to be shown to other participants.

20. A terminal-side apparatus according to claim 18, wherein the charted location of the latest speaker is indicated by a shape, color, or method different from those for other speakers when charting the locations of the participants who are in said area chat room.

21. A terminal-side apparatus according to claim 18, wherein the charted location of the local terminal is indicated by a shape, color, or method different from those for the other participants when charting the locations of the participants who are in said area chat room.

22. A terminal-side apparatus according to claim 18, further comprising:
remark location search processing means for retaining the time and location of each received remark, accepting a remark location search request to search for the location of a specific remark displayed on the display screen of said terminal, and charting the location where said remark was made, using a shape, color, or method different from those for the locations of the other participants.

23. A terminal-side apparatus according to claim 22, wherein, after accepting a remark location search request, calculating the distance between the location at the time of said remark and the current location of the terminal and displaying it on the display of said terminal.

24. A terminal-side apparatus according to claim 18, further comprising:
room creation request processing means for sending said system a room creation request to create an area chat room with its range specified based on the current location of said terminal or a user-specified location.

25. A terminal-side apparatus according to claim 24, wherein said room creation request contains information to limit the participants who are allowed in the area chat room created.
